(19) United States
(12) Patent Application Publication
(10) Pub. No.: US 2010/0121651 A1
(43) Pub. Date: May 13, 2010

(54) Systems and Methods for Evaluating Information to Identify, and Act Upon, Intellectual Property Issues

(76) Inventor: Hazim Ansari, Tustin, CA (US)

Correspondence Address: PATENTMETRIX, 14252 CULVER DR. BOX 914, IRVINE, CA, 92604, US

(21) Appl. No.: 12/617,304

(22) Filed: Nov. 12, 2009

Related U.S. Application Data
(63) Continuation of application No. 10/997,509, filed on Nov. 24, 2004, now abandoned.
(60) Provisional application No. 60/524,700, filed on Nov. 24, 2003.

(51) Int. Cl. G06Q 99/00

(52) U.S. Cl. 705/1.1

(57) ABSTRACT

The systems and methods of the present invention enable users to identify whether a composition of matter, technical design, product, service, component, technology, feature, business model or any other item may have intellectual property issues associated therewith. The present invention includes a set of screens, filters, comparison sheets, and/or questionnaires (referred to generically as screens) which are derived from patent claims and used to evaluate whether a composition of matter, technical design, product, service, component, technology, feature, business model or any other item may have intellectual property issues associated therewith. The present invention further comprises systems and methods designed to help groups of people, in a collaborative environment, manage the use of screens.

### CROSS-REFERENCE

The present invention application is a continuation of U.S. patent application Ser. No. 10/997,509, filed on Nov. 24, 2004, which relies on U.S. Provisional Patent Application No. 60/524,700, filed on Nov. 24, 2003 for priority purposes.

### FIELD OF THE INVENTION

The present invention relates generally to methods and systems for conducting evaluations of information, such as technical designs, for intellectual property (IP) issues and, more specifically, for providing a network for determining what patents are applicable to which product or service markets and enabling the organization of patents into market structures from which relative value can be assigned on a total market basis.

### BACKGROUND OF THE INVENTION

Companies attempting to make, use, sell, offer for sale, or import a product or service find it difficult to determine whether one or more patents prohibits such making, using, selling, importing or offering for sale without a license from a third party patent owner. While, in theory, products and services could be reviewed by a qualified patent attorney for possible infringement issues, the extraordinary complexity of technologies, product, and services, along with the sheer numbers of patents, make it very difficult, if not impossible, to conduct a thorough review in a time-efficient and cost-effective manner. Having non-patent professionals, such as engineers, conduct such reviews is not feasible because a) they are often unable to properly interpret patent claims and b) companies are fearful of having its employees know specific patents and, therefore, gain actual knowledge of third party intellectual property rights.

To date, therefore, there has been no cost effective, efficient product or service clearance solution that allows companies to be in compliance with intellectual property rights owned by third parties. Intellectual property infringement, specifically patent infringement, is therefore a multi-billion dollar on-going risk management issue for companies. Currently, there is no solution to address it. As a result, companies tend to operate without clarity as to whether any patents cover their products or services. This lack of clarity creates a number of distinct problems:

1. The “Who's Next” Problem: A company subjected to a demand for royalty is often unable to agree to a settlement, not because the royalty being demanded is unreasonable, but because the company recognizes that it can not afford to open the gate to numerous patent holders, the combined demands of which may sink its business. Stated differently, certain companies may be willing to pay a single toll if they felt assured that, doing so, they move from point A to point Z without further delay. However, if they believed it possible that, at points B, E, L, Q, they may be subjected to tolls from yet unidentified entities, they will opt for taking a hard stand against paying any tolls. Uncertainty over what patents apply to products and services and how they relate to a company's business drive this problem.

2. The “Unrealistic Expectation” Problem: Having no appreciation for the various patents that may apply to a product or service, patent holders often think in terms of what royalties licensees could theoretically pay, without considering the “Who's Next” problem or recognizing that, if the licensees are subjected to multiple similar demands for royalties, it would stunt the market. Patent holders therefore often have unrealistic expectations of how much royalty, or tax, a specific market, product, service, or technology sector can bear. This leads to excessive royalty demands and inaccurate estimations of the value of a patent asset. Once again, a lack of clarity as to the totality of patents that cover specific markets underlies this problem.

3. The “Blind Development” Problem: Ideally every company would undertake a patent infringement analysis before beginning a product or service development cycle. Given the time and money involved, this is hard to justify and not feasible to manage. Companies often take it for granted that they may infringe a patent and hope that either they'll have patents to use in response to a lawsuit or that the patent holder is not litigious. Without insight as to what patents may cover their development activities, companies opt for the safe route and marginalize patent assets as defensive shields because using patents offensively might uncover infringement liabilities they feared, but never knew, existed.

4. The “Latent Value” Problem: A patent is an asset. Like land, a company can choose to put it to productive use, or let it lay fallow, draining corporate coffers from periodic property tax payments. Most executives intuitively understand that, even if unused, land has some latent value. Such an understanding, however, does not necessarily extend to patents. The latent value of a patent is difficult to see because, without insight as to what patents are relevant to which markets, patents tend to stay hidden, thereby masking any value they may have. Determining latent value often requires a company to spend thousands in legal fees—something most companies are unwilling to do.

5. The “Junk Patent” Problem: Where patents are used as defensive shields, the more a company has, arguably the better positioned it may be. However, for many companies, simply filing many patents is not an economically feasible strategy. Rather, companies would rather focus on filing quality patents, but filing quality patents requires insight into what patent scope coverage would be most economically beneficial for a company. That, in turn, requires knowledge of how patents relate to a specific products and services—knowledge that most companies do not have.

Because patents define inventions and not economic units, they are removed from any market context and, therefore, are necessarily difficult to value and create. To properly address deficiencies in our patent system, we must first recognize that patents need an efficient mechanism through which they can be placed in some type of economic context.

It is therefore desirable to have systems and methods for providing an objective patent market maker function that associates the legal language defining an invention with the product/service language defining a recognized economic unit to create a bridge that places individual patents into a market context.

It is further desirable to integrate the identification of patent issues into the engineering or technical design process itself. By having products and services screened for patent issues in real-time, one can avoid having to re-engineer the products/services and not require excessive attorney analysis time.

It is further desirable to have a clearinghouse that proactively receives notices that certain patents are an issue and assists in eliminating those patents as barriers to operation by providing the notifying company with information on the invalidity of the patent, the scope of the patent, the license terms of the patent, litigation status of the patent, and other patent specific information.

### SUMMARY OF THE INVENTION

In one embodiment, the present invention comprises a plurality of steps designed to enable a person, referred to as a reviewer, to identify whether a composition of matter, technical design, product, service, component, technology, feature, business model or any other item may have intellectual property issues associated therewith. An intellectual property issue can refer to whether an item infringes, violates, implicates, covers, or otherwise brings into question intellectual property, such as trademarks, copyrights, or patents, owned by another person, company, institution, or entity.

In another embodiment, the present invention also includes a set of screens, filters, comparison sheets, and/or questionnaires (referred to generically as screens) which are derived from patent claims and used to evaluate whether a composition of matter, technical design, product, service, component, technology, feature, business model or any other item may have intellectual property issues associated therewith. In another embodiment, the present invention includes a database of metadata describing the screens and capable of being indexed by market, product, service, component, feature, technology area, engineering task or any other technically driven criteria.

In another embodiment, the present invention further comprises systems and methods designed to help groups of people, in a collaborative environment, manage the use of screens. In another embodiment, the present invention further comprises systems and methods designed to enable the resolution of IP issues identified by use of screens or evaluation of patent information.

The systems and methods of the present invention include an intellectual property analysis system comprising a central repository having a plurality of screens wherein at least one screen represents at least one patented invention and wherein said screen does not comprise patent identifying indicia; an index defining the relationship between the at least one screen and patent identifying indicia related to said patent invention; and a server capable of delivering said screen to a user for review and of receiving said review.

Optionally, the review comprises a comparison of said screen against a product, service, or technology. The review comprises a determination whether said product, service, or technology includes every element of the screen. The review comprises a determination whether said screen should be flagged for further review. The review is communicated to a central repository for storage.

Optionally, the review is communicated to a user for a legal analysis. At least a portion of the index is communicated to the user. The review is a marked version of the screen. The marked version is stored separate from the screen and does not replace said screen.

Optionally, the further comprises a screen selection interface that enables a selection of a plurality of screens based on a plurality of criteria. The criteria include at least one of a feature, component, design element, market, product, service, research area, workgroup area, or technology area. Optionally, the system is in data communication with product life cycle software.

In another embodiment, the present invention includes a method for performing an evaluation of intellectual property issues comprising the steps of providing, in a central repository, a plurality of screens wherein at least one screen represents at least one patented invention and wherein the screen does not comprise patent identifying indicia; providing an index defining the relationship between the at least one screen and patent identifying indicia related to the patent invention; delivering the screen to a user for review; and storing the review.

Optionally, the method further comprises the step of communicating the review to a user for a legal analysis. At least a portion of the index is communicated to the person. The method further comprises the step of offering the user information wherein the information includes at least one of a validity analysis, a plurality of references, transaction information, royalty information, acquisition information, licensing information, or assignee information.

Optionally, the method further comprises the step of providing a screen selection interface that enables a selection of a plurality of screens based on a plurality of criteria. The criteria include at least one of a feature, component, design element, market, product, service, research area, workgroup area, or technology area. The method further comprises the step of providing an indication of review status.

### BRIEF DESCRIPTION OF THE DRAWINGS

These and other features and advantages of the present invention will be appreciated, as they become better understood by reference to the following Detailed Description when considered in connection with the accompanying drawings, wherein:

FIG. 1 is a graphical representation of one embodiment of a screen;

FIG. 2 is a flowchart representation of another embodiment of a screen;

FIG. 3 is a tabular representation of one embodiment of an index;

FIG. 4 is a tabular representation of another embodiment of an index; and

FIG. 5 is a flowchart representation of one embodiment of a method of using screens.

### DETAILED DESCRIPTION OF THE INVENTION

In one embodiment, the present invention comprises a plurality of steps designed to enable a person, referred to as a reviewer, to identify whether a composition of matter, technical design, product, service, component, technology, feature, business model or any other item may have intellectual property issues associated therewith. An intellectual property issue can refer to whether an item infringes, violates, implicates, covers, or otherwise brings into question intellectual property, such as trademarks, copyrights, or patents, owned by another person, company, institution, or entity.

In another embodiment, the present invention also includes a set of screens, filters, comparison sheets, and/or questionnaires (referred to generically as screens) which are derived from patent claims and used to evaluate whether a composition of matter, technical design, product, service, component, technology, feature, business model or any other item may have intellectual property issues associated therewith. In another embodiment, the present invention includes a database of metadata describing the screens and capable of being indexed by market, product, service, component, feature, technology area, engineering task or any other technically driven criteria.

In another embodiment, the present invention further comprises systems and methods designed to help groups of people, in a collaborative environment, manage the use of screens. In another embodiment, the present invention further comprises systems and methods designed to enable the resolution of IP issues identified by use of screens or evaluation of patent information.

A screen preferably serves to provide technicians, engineers, or other persons responsible for devising a product or service with a mechanism to identify whether a patent issue may exist. A screen is therefore a graphical representation, tabular breakdown, flowchart, or any other representation of one or more patent claims. Preferably, a screen is provided in a form or language that is understandable to a technical, but not necessarily patent-knowledgeable, audience. Additionally, it is preferred that the screen be presented such that it is equal to or broader than the actual claim scope. Specifically, it is preferred that, when a screen is applied to a design, it captures the possibility of a patent issue. That possibility can then be evaluated more specifically by a qualified patent professional.

For example, suppose one had a patent claim structured as follows:

1. A method including:

creating a first secure container including a first governed item and having associated a first control;

creating a second secure container including a second governed item and having associated a second control;

transferring the first secure container from a first location to a second location;

transferring the second secure container from a third location to the second location;

at the second location, obtaining access to at least a portion of the first governed item, the access being governed at least in part by the first control;

at the second location, obtaining access to at least a portion of the second governed item, the access being governed at least in part by the second control;

at the second location, creating a third secure container including at least a portion of the first governed item and at least a portion of the second governed item and having associated at least one control, the creation being governed at least in part by the first control and the second control.

A screen would be developed that represented the above claimed method in a manner that one of ordinary skill in the art could readily understand and appreciate. The screen would preferably represent the claim in a technical format and/or with technical language that is equal to or broader than the scope of the claim. Additionally, it is preferred that, when delivered to certain audiences, such as non-attorney reviewers, the screen be separate and isolated from the patent-identifying indicia. In this case, the patent-identifying indicia would include the patent number (U.S. Pat. No. 6,389,4020), the claim from which the screen was derived (claim 1), filing date (Jun. 9, 1999), issue date (May 14, 2002), priority data, references, inventor names and address, classification numbers, and any other data that could be used to identify the actual patent.

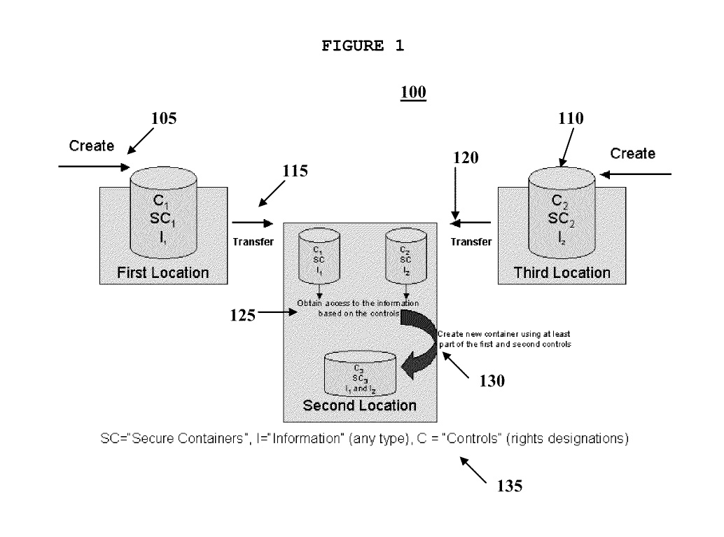

An exemplary graphical representation of such a claim is provided in FIG. 1. The graphical representation creates a screen for a patent claim in a manner that is understandable to persons who are not patent professionals. Each step of the method 100 is associated with a part of the Figure.

In 105, a first secure container including a first governed item and having associated a first control is created. In 110, a second secure container including a second governed item and having associated a second control is created. In 115, the first secure container is transferred from a first location to a second location. In 120, the second secure container is transferred from a third location to the second location. In 125, at the second location, access is obtained to at least a portion of the first governed item, the access being governed at least in part by the first control and access is obtained to at least a portion of the second governed item, the access being governed at least in part by the second control. In 130, at the second location, a third secure container is created including at least a portion of the first governed item and at least a portion of the second governed item and having associated at least one control, the creation being governed at least in part by the first control and the second control. For ease of presentation, definitions 135 are also provided in the figure.

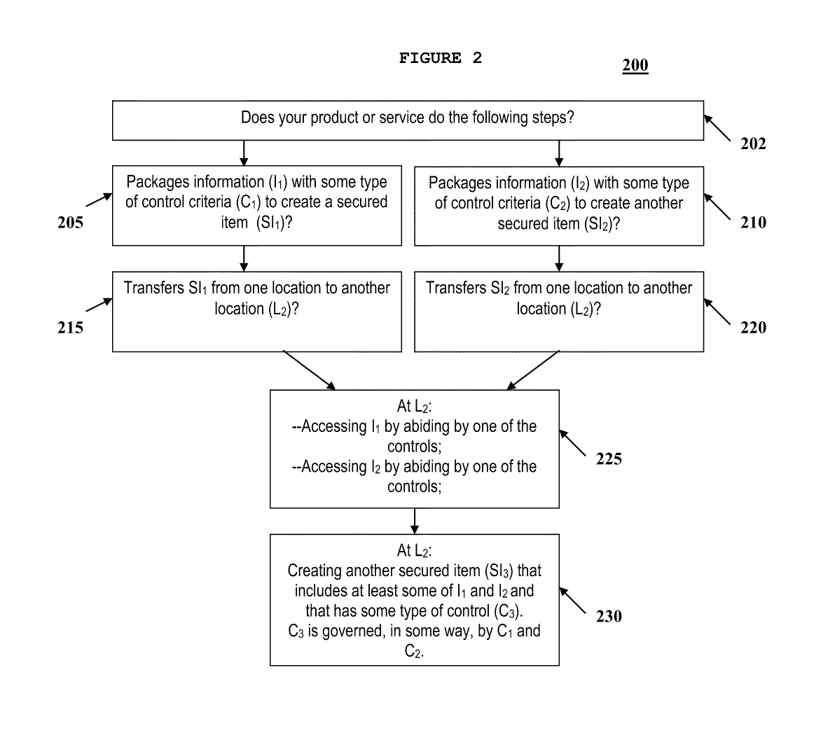

A second exemplary representation of such a claim is provided in FIG. 2. The flowchart representation presents a series of questions and/or statements that, when asked and answered by persons who are not patent professionals, enable the identification of whether the patent claim from which the screen was derived may apply to the product or service at issue.

In 202, the screen 200 initiates by asking a base question, namely does the product or service being evaluated do a certain set of steps, as determined by a plurality of additional, preferably “yes” or “no” questions. In 205, the question asks if the product or service packages information (I₁) with some type of control criteria (C₁) to create a secured item (SI₁)? In 210, the question asks if the product or service packages information (I₂) with some type of control criteria (C₂) to create another secured item (SI₂)? In 215, the question asks if the product or service transfers SI₁ from one location to another location (L₂)? In 210, the question asks if the product or service transfers SI₂ from one location to another location (L₂)? In 225, the question asks if, at L₂, the product or service accesses I₁ by abiding by one of the controls and accesses I₂ by abiding by one of the controls? In 230, the question asks if, at L₂, the product or service creates another secured item (SI₃) that includes at least some of I₁ and I₂ and that has some type of control (C₃) where C₃ is governed, in some way, by C₁ and C₂? For ease of presentation, definitions (not shown) could also be provided in the flowchart.

It is preferred that the screen does not identify the patent from which it was derived. By not including the patent identifying indicia, an organization can widely distribute the screens without worrying about being accused of willful patent infringement or having its engineers knowingly use the intellectual property rights of third parties. It is preferred that the association of screens with patent identifying indicia, such as patent numbers, assignees, inventors, issue date, filing date, priority date, claim numbers, and reference citations, be done in the form of a first index that is kept separate from the screens. When a screen is identified as being an issue, only certain parties, such as a designated manager or attorney, can reference the first index using the screen to identify the patent and, thereafter, conduct an in-depth analysis of the patent to address the identified issue.

In another embodiment, a single screen is designed to cover multiple patent claims that are similar in scope. The patent claims can be from the same, or different, patents. The key objective, however, is to define a filter or screen that can accurately be used to identify whether one or more patent claims, from one or more patents, is implicated by a particular technical design.

This innovation is intended to cover the core concept of transforming patent documents into technical specifications that are devoid of any patent identifying indicia or implications of specific patents. That transformation can occur manually, by having individuals read each patent, identify the important patent claims, select certain patent claims to characterize, and create flowcharts, questionnaires, and/or graphical figures based upon said claims. The transformation could also occur automatically through machine-mediated interpretation of claim language. In such applications, a natural language analytical engine examines designated claims and breaks down those claims into an understandable representation.

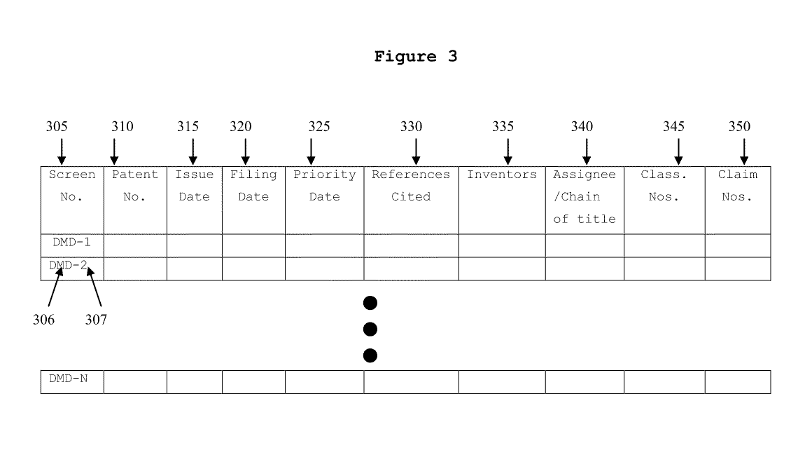

Referring to FIG. 3, a first index of screen and patent information is provided. The index is in the form of a data structure, preferably stored in a memory medium in association with a computing system. The data structure records metadata information about the patent and lists it in relation to the screen identification information. The screen identification information 305 could be a number, a description, a technology field, or any other type of identifier. In a preferred embodiment, it comprises a market designator 306, which provides some indication to which market, product, service, or technology the screen is relevant, and a numerical value 307 to act as an ordering value. The patent metadata information can include any descriptive or statistical information about the patent, including patent numbers 310, assignees 340, inventors 335, issue date 315, filing date 320, priority date 325, claim numbers 350, reference citations 330, chain of title information 340, number of claims, type of claims, number of independent claims, number of dependent claims, classification information 345, and/or metadata information of related patents or patent applications.

It is preferred that an entire set of screens is generated to cover a specific feature, technology, component, product or service in a particular market. This will allow technical teams to conduct real-time, comprehensive reviews of products and services being developed on a feature-by-feature basis. This invention is designed to create a link between technology, as defined on a market basis, with patent information. Therefore, it would be preferable to create and organize screens on market, technology, component, product, service, or some other recognizable economic unit basis.

To do so, a patent search should first be conducted to identify all patents related to that feature, technology, component, product or service. Then, the most relevant patents are selected, the key claims from those patents are then chosen, screens are derived from those key claims, and metadata of the screen information is provided in a second index and preferably stored in a central database.

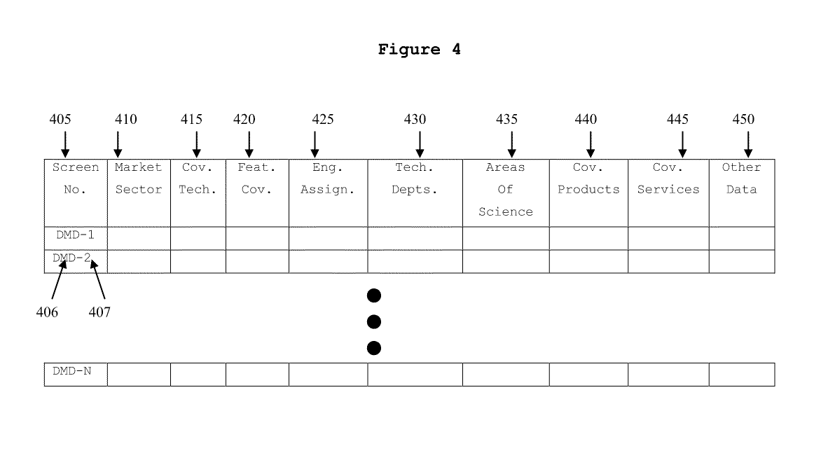

Preferably, the second index is constructed to mirror the product, technical, market, or service requirements of the product or service being developed. Referring to FIG. 4, an exemplary second index is shown. The second index is in the form of a data structure, preferably stored in a memory medium in association with a computing system. The data structure records metadata information about the screen in relation to the technology area of interest. The screen identification information 405 could be a number, a description, a technology field, or any other type of identifier. Preferably, it includes a market identifier 406 and numerical value 407, as described above. The screen metadata information can include any descriptive or statistical information about the screen, including market sector 410, technology covered by the screen 415, features covered by the screen 420, types of engineering assignments that would require referencing the screen 425, technical departments 430, areas of science 435, products covered by the screen 440, services covered by the screen 445, and/or metadata information of other screens 450.

In one embodiment the search is preferably performed using the following novel search system and methodology. A technology, feature, service, product, or other technology unit is identified. A first search is then constructed to determine a first set of patents that are relevant to the technology, feature, service, product, or other technology unit. The search could be in the form of a keyword search, where a few keywords are selected, an assignee search, where certain companies are dominate in a market, or a specific patent number search, where certain patent numbers are already known to be relevant. The search can be conducted on any patent database, such as those provided by Lexis-Nexis, Delphion, or the U.S. Patent and Trademark Office. The first search preferably yields a first set of patents that are relevant to the technology, feature, service, product, or other technology unit.

Once a first set of patents is identified (patent set 1), preferably in the range of greater than 3 patents, the patent references cited by each of those patents are identified (patent set 2ᵣ₁ to 2ᵣ₄ where 4 patents are in patent set 1). The patents that cite to the first set of patents are also identified (patent set 2_{C1} to 2_{C4} where 4 patents are in patent set 1). For each patent set (2ᵣ₁ to 2ᵣ₄ and 2_{c1} to 2_{c4}), the same process is performed, namely patent references cited by each patent in the patent sets is identified and patents which cited to each patent in the patent sets is identified. While theoretically one can go down numerous iterations, it is preferred to extend no more than 3 to 4 branches beyond the original first set of patents.

The patent number of each patent identified in each of the searches is cataloged. At the completion of the search, the number of times the patent is identified is calculated. The patents with the most frequent identification are considered to be the most relevant. Therefore, in a distribution curve, those patents closest to the center of the distribution curve are selected as being the most relevant.

It is preferred to conduct this type of search using a Java-based or C+ based client-based application that operates on a computer system, such as Microsoft's Windows, in association with the standard processing and memory devices. The client-based application receives, as inputs, a set of initial patent numbers (the first set of patents) and, optionally, a market identifier defining what market the search is attempting to cover. The client-based application outputs a set of patents, starting from the most relevant (most frequently cited) to the least relevant. Preferably, the output is structured as a display in which the most frequently identified patents are in bold or in a colored tier and less frequently identified patents are in different colored tiers. A user could therefore organize his or her results using a sliding frequency scale that changes the size of the relevancy band based upon how many, or how few, results they want to consider.

The client-based application could be part of a larger distributed computing network, e.g. a peer to peer network, in which various searches are catalogued and shared among multiple peer users. In one embodiment, one client application can communicate with another client application and see what kinds of searches it performed to identify patents covering a specific technology, feature, market, service or product.

Once the relevant patents are identified, screens are manually or automatically generated, as previously discussed. The screens are catalogued, as discussed in relation to FIGS. 3 and 4 above, and stored in a repository, such as an memory, server, database, or storage medium.

In one embodiment, the screens are used in accordance with the following method:

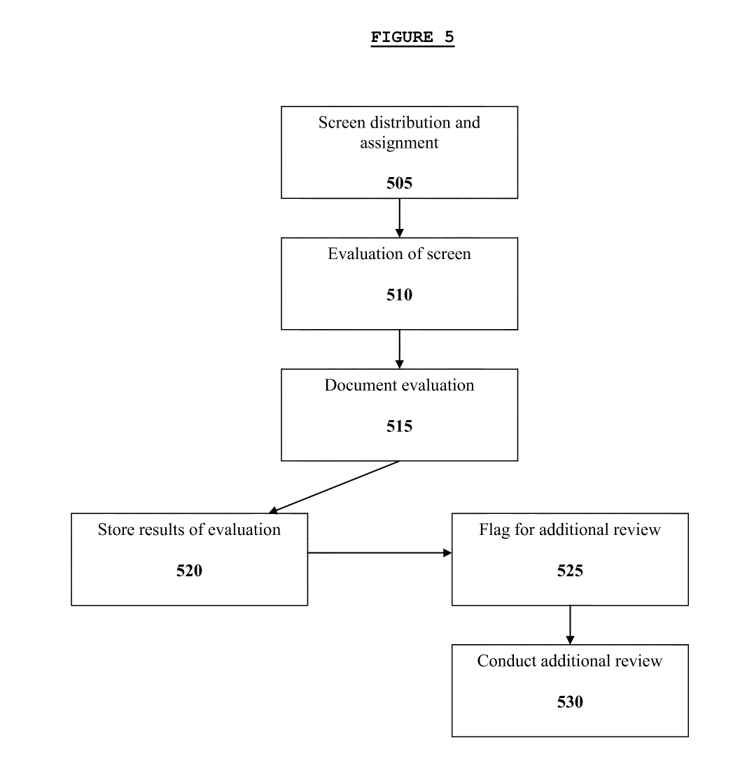

1. Referring to FIG. 5, one or more screens are distributed 505 to reviewers who are typically, although not necessarily, technically skilled individuals. The reviewers are assigned 505 a specific screen or set of screens to evaluate against a specific design, feature, product, service or technology. Typically, the index would be used to identify a particular feature or technology component that a specific reviewer has knowledge of and the screens associated with that feature or component would be assigned to the reviewer. One of ordinary skill in the art would appreciate that a reviewer refers to any user of the system, including an employee, executive, contractor, evaluator, manager, or other individuals, and that the act of “reviewing” encompasses any form of using the screens, such as evaluating, considering, manipulating, analyzing, among other definitions.

2. The reviewer evaluates 510 the design by comparing the screen to the design. If the design does not encompass each element of the screen, the reviewer can note down 515, on an accompanying evaluation form, on the screen itself, or in an text providing space in the client device, the absence of that element. Preferably these evaluation forms are transmitted to a central repository 520 and controlled by a manager. This has the added benefit of being able to reference a review in case a cease and desist letter is later received for a particular patent whose invention was reviewed in the form of a screen.

3. If the design does encompass each element of the screen, the reviewer can flag 525 the screen and bring it to the attention of a manager or attorney. An individual, typically an attorney, who is authorized to see the master index linking patent information with screen information is then requested to determine 530 whether the patent (as implicated by the flagged screen) does in fact cover the design, feature, component, or technology being evaluated. This person then conducts a legal analysis or review 530 of the patented invention in light of the design, product, service or technology.

In another embodiment, the present invention further comprises systems and methods designed to help groups of people, in a collaborative environment, use the screens and manage the use of screens. A network-based or web-based interface is provided that allows a user, typically an engineer or technically competent person, to identify a set of screens for use in evaluating a design (referred to as a screen selection interface). Preferably, a user can click down a series of links or menu items to identify the specific feature, component, design element, market, product, service, research area, workgroup area, or technology area of interest (collectively “criteria”). One of ordinary skill in the art would appreciate that the process of identifying criteria can include clicking a series of dialog boxes, links, or other inputs that progressively narrow the field of interest until specific criteria is identified and can be related to a specific set of screens.

Once a sufficiently narrow criteria set is established and a specific set of screens is identified, those screens are logged into the user's personal account. Preferably, the screens are stored in a central database in accordance with a screen identifier. Once the criteria set is identified, an index is accessed to obtain all screen identifiers associated with that criteria set. The screen identifiers are then used to access the central database and obtain links to the identified screens. The screen links are then incorporated into the on-line user account. Alternatively, they may downloaded into a client-based application or made available for access to a client-based application. Regardless of the approach, a library of screens is created covering the technology, feature, design area of interest. The screens can be allocated to one or more user accounts.

The screens, when initially allocated to the user, are identified by links which, if clicked, would go to a different web page, or pop up a window, displaying the screen associated with the link. It is further preferred that the link of initially allocated screens are designated as having not been evaluated or being in an “un-reviewed” state. This can be accomplished by having the links to those screens be a different color than reviewed screens, placing those links into a specific box, or otherwise differentiating those screens from evaluated screens. Alternatively, the system can provide for thumbnail representations of the screens or other representations that indicate the existence of a screen in a user's account.

When a user clicks on a screen link and reviews a screen, he is preferably provided with a series of reviewing options that can improve and/or streamline his evaluation. The user preferably has the option to “whiteboard” the screen by marking it up for capturing notes. One of ordinary skill in the art would appreciate that the user is just making another version of the screen and not modifying the original screen as it exists in a central database. The user also preferably has the option to share the original screen or marked up screen by emailing it to another user or alternatively to send the original screen or marked up screen to another user's account in the on-line system. The second approach is preferable since it permits some degree of control and allows an administrator to designate which users are authorized to receive screen information and which persons are not.

The user also preferably has the option to record an evaluation of the screen relative to the design, feature, technology component, product or service. The evaluation recordation could occur by providing the user with a text entry box which the user can use to enter evaluation information, or other data input means that can capture a user's evaluation. Preferably that evaluation information is associated with the user's version of the screen and stored.

The user also preferably has the option to categorize the screen as having a particular state, such as being reviewed, not reviewed, a problem, still under investigation, requires a second opinion, requires a manager's review, requires legal review or any combination of the above by clicking on the appropriate buttons or boxes associated with the screen. The status categorization designates how the screen will be categorized in the user's account and whether the screen will be transmitted to another individual for a second opinion or review.

For example, if the screen is categorized as being not reviewed, the screen link in the user's account remains the same color and/or stays in the same location. If the screen is categorized as being reviewed, the screen link in the user's account changes color and/or moves to a different location. If the screen is categorized as being a problem, the screen link in the user's account is highlighted, preferably in a bright red color, and/or moves to a different location. If the screen is categorized as still under review, the screen link in the user's account is highlighted, preferably in a bright red color, and/or moves to a different location. If the screen is categorized as requiring a second opinion, a manager's review, or a legal review, the screen link is transmitted to an individual whose account information indicates that he or she is a manager for that user, a provider of a second opinion for that user, and/or a legal resource for that person. The link is communicated to that person, either by email or by having the link appear in their account, along with an explanation that the user wanted some action taken on their behalf. One of ordinary skill in the art would appreciate there are many ways to present screen categorizations and organize the information. All such approaches are within the scope of this invention.

Preferably, if the screen is not a problem, it is saved with the evaluation information in a project database. That project database will store all screen and evaluation information on a project, product, or service basis. It is also preferred that all activities of users are tracked by a monitoring server. Specifically, the monitoring server tracks which users access what screens and maintains a log of such information and how screens have been categorized by various users.

In another embodiment, the present invention further comprises systems and methods designed to enable the resolution of IP issues identified by use of screens or evaluation of patent information. Where a user causes a screen to be communicated to an attorney, the attorney may likely need to have additional information to evaluate whether the patent implicated by the screen does, in fact, pose a problem. Preferably, the attorney has access to an index, either in hardcopy or on-line, that relates the screen information to one or more patents/patent claims.

Conventionally, an attorney would then conduct an infringement and/or invalidity analysis of the patent(s) at issue. In the present invention, it is preferred that, when a user categorizes a patent as requiring legal review, that user information, screen information, and legal reviewer information is transmitted to a server which, using the index, identifies what patents are at issue and communicates, via the legal reviewer's email or the legal reviewer's on-line account, an offer to provide the legal reviewer with completed validity studies on the patent, all of the references cited by the patent, a litigation history of the patent, a claim interpretation of the patent, and any and all information a legal reviewer may need in conducting an evaluation of the patent. The legal reviewer can then accept some or all of the information offers by clicking on boxes and authorizing a purchase of that additional information.

Additionally, it is preferred that the system be capable of offering the legal reviewer deal information regarding the patents at issue, including royalty or acquisition information. In one embodiment, the present system functions as a clearinghouse that proactively receives notices that certain patents are an issue (through the categorization of technical users) and offers legal reviewers the ability to anonymously investigate the costs of a license or of acquisition. For example, the present invention further provides legal reviewers the ability to order license data or acquisition data and/or obtain contact information for patent licensing or sales representatives without revealing their identity.

In another embodiment, the present invention is integrated into, or made compatible with, a product life cycle management system. A preferred product life cycle management system (PLCMS) comprises automated task routing enabling a project manager to define the parameters of a task and have it automatically routed to the appropriate employee or contractor. A PLCMS enables users to post progress reports, resolve issues, add tasks, or collaboratively work together to address project concepts. Users are able to create projects using a series of templates. A PLCMS further allows for the management of issues and expenses, along with a project library that serves as a repository of historical work. Each user can keep track of their tasks and participate in the planning and estimating process. The PLCMS can be integrated with asset management software, bug tracking software, software design, help desk software, and sales management software. The present invention integrates or is made compatible with a PLCMS by having screens and screen evaluations part of a user account having the aforementioned functionality, among other approaches.

Preferably, reports can be generated that capture the status of screen evaluations, also referred to product clearance or patent compliance. Such reports include:
1. A list of all screens and who is assigned to review the screens.
2. A list of all screens that have been flagged as being reviewed.
3. A list of all screens that have been flagged as being not reviewed.
4. A list of all screens that have been flagged as being a problem.
5. A list of all screens that have been flagged as being still under investigation.
6. A list of all screens that have been flagged as requiring a second opinion.
7. A list of all screens that have been flagged as requiring a manager's review.
8. A list of all screens that have been flagged as requiring a legal review.
9. A report combining any combination of the above.
10. A report providing any of the above information on a user basis.
11. A report concluding whether the technology under review is cleared from an IP perspective or not.

The present invention further comprises the use of the screens and software platform described herein to evaluate a company's liabilities, determine its risk exposure, and derive insurance coverage. In one embodiment, an insurer requires a company to adopt the solution and sign off on the screens prior to issuing the company any insurance coverage for intellectual property infringement. In another embodiment, the patent infringement liability, including frequency of being sued, success of suits, monies expended on litigation defense, and monies expended on damage awards, are tracked for those companies who adopt or comply with the screens and compared to those companies who do not adopt or comply with the screens. The information, stored on a memory medium and processed using a computer, is then used to conclude whether a company which complies or adopts the screens is less likely to get sued and, therefore, deserves a lower insurance rate than those companies who do not comply or adopt the screens.

The present invention covers all permutations and variations of methods and systems that separate patent-identifying information from patent claims to yield a screen described in technical language, use such screening information to identify possible patent issues, and use the identification of possible patent issues to deliver additional services such as information for helping in the evaluation of a patent, licensing of a patent, or acquisition of a patent.

It should further be appreciated that the computer management systems described herein can be architected, accessed, and/or supported in a plurality of ways. The networks used herein can be wired or wireless and the client devices used to access the system can be personal computers, personal data assistants, mobile phones, network-enabled televisions, among other computing devices.

We claim:

1. A software-based intellectual property analysis system comprising:
A web-based screen selection interface, wherein said web-based interface provides a plurality of inputs through which screen selection criteria are identified, wherein said criteria includes at least one of a design element, product, service, or technology area;
central repository having a plurality of screens wherein at least one screen represents at least one invention patented by a patent, said patent having a patent number, and wherein said screen does not identify said patent number;
a first index, stored in a memory, for relating the at least one screen and said patent number;
a second index, stored in a memory, for relating the patent number and said screen selection criteria;
a server configured to assign said at least one screen to a user account based upon an identification of said screen selection criteria; and
at least one interface configured to permit a user to view said at least one screen, post an evaluation of said at least one screen, and categorize said at least one screen.

2. The system of claim 1 wherein said evaluation of said at least one screen comprises a comparison of said screen against a product, service, or technology.

3. The system of claim 1 wherein said evaluation of said at least one screen comprises a determination whether said product, service, or technology includes every element of the screen.

4. The system of claim 1 wherein said at least one interface is configured to permit a user to flag said screen for further review.

5. The system of claim 1 wherein said at least one interface is configured to permit a user to communicate said evaluation of said at least one screen to a repository for storage.

6. The system of claim 1 wherein said at least one interface is configured to permit a user to communicate said evaluation of said at least one screen to another user.

7. The system of claim 6 wherein said first index comprises at least one of a market, product, service, component, feature, technology area, or engineering task description with respect to said at least one screen.

8. The system of claim 7 wherein at least a portion of said first index is communicated to said another user with said evaluation.

9. The system of claim 1 wherein said evaluation is a marked version of said screen.

10. The system of claim 9 wherein said marked version is stored separate from the at least one screen.

11. The system of claim 1 further comprising an application for conducting a search for patent relevant to said design element, product, service, or technology, wherein said at least one screen is derived from a patent claim identified in said patent search.

12. The system of claim 11 wherein said application comprises an input for receiving a first set of patents and processes said first set of patents to identify a plurality of other patents.

13. The system of claim 12 wherein said application processes said first set of patents to identify said plurality of other patents by identifying patents that reference each of said first set of patents to create a first reference patent list and identifying patents that are cited by each of said first set of patents to create a first cited patent list.

14. The system of claim 13 wherein said application processes said first set of patents to identify said plurality of other patents by, after creating said first reference patent list, identifying patents that reference each of said patents in said first reference patent list to create a second reference patent list.

15. The system of claim 14 wherein said application processes said first set of patents to identify said plurality of other patents by, after creating said first reference patent list, identifying patents that are cited by each of said patents in said first reference patent list to create a second cited patent list.

16. The system of claim 15 wherein said application processes said first set of patents to identify said plurality of other patents by, after creating said first cited patent list, identifying patents that reference each of said patents in said first cited patent list to create a third reference patent list.

17. The system of claim 16 wherein said application processes said first set of patents to identify said plurality of other patents by, after creating said first cited patent list, identifying patents that are cited by each of said patents in said first cited patent list to create a third cited patent list.

18. The system of claim 17 wherein said application catalogs a patent number corresponding to each patent in each of said first, second, and third reference patent list and first, second, and third cited patent list.

19. The system of claim 17 wherein said application determines a frequency by which each of said patent numbers corresponding to each patent in each of said first, second, and third reference patent list and first, second, and third cited patent list appears.

20. The system of claim 19 wherein said application identifies said plurality of other patents based upon said frequencies.
